(19) United States
(12) Patent Application Publication
(10) Pub. No.: US 2024/0120872 A1
(43) Pub. Date: Apr. 11, 2024

(54) Solar Panel Accessory

(71) Applicant: Verdant Maintenance Control LLC, Stillwater, MN (US)

(72) Inventor: Joseph M. Peltier, Stillwater, MN (US)

(21) Appl. No.: 18/377,491

(22) Filed: Oct. 6, 2023

Related U.S. Application Data
(60) Provisional application No. 63/413,787, filed on Oct. 6, 2022.

(51) Int. Cl. H02S 20/10; A01G 13/02; F16B 5/00

(52) U.S. Cl. CPC H02S 20/10; A01G 13/0206; F16B 5/0028

(57) ABSTRACT

A solar farm includes a plurality of I-beams having a first attached end and a free end. A plurality of solar panels are mounted to the free ends of the plurality of I-beams. The solar farm also includes a plurality of vegetation management shields attached to the plurality of I-beams. The vegetation management shields are positioned at or near the ground and prevent vegetative growth near the plurality of I-beams. At least one vegetation management shield includes a disk having a first side, and a second side. The disk of the at least one vegetation management shield has an I-beam-shaped opening therein. The opening passes through the disk. The disk also includes a rib structure positioned between the first side of the disk and the second side of the disk. The disk can also be formed as a first portion and a second portion that fits around an I-beam.

### BACKGROUND

In the past, fossil fuels, such as coal, natural gas, and diesel fuel were used to produce a majority of the electrical power around the world. Burning fossil fuels pollutes the atmosphere and also produces carbon dioxide which may be a contributing factor in global warming. So, over the past 20-30 years, there has been a move away from generating electricity using fossil fuels to generating electricity using renewable or green energy sources. Government bodies and now power companies have goals to produce more electricity using renewable sources. The trend is to continue into the future. Wind generators and solar panels are now two of the top renewable sources of electrical energy. Solar panels can be seen on many residential homes or small businesses now. Furthermore, there are larger commercial operations and it increasingly more common to see wind farms and solar panel farms along roadways. Generally, solar farms include acres of solar panels. Many solar panels can be placed on one farm. For example, a smaller farm with 12 acres could have over 2000 solar panels thereon. Advantageously, the transmission equipment can also be placed on or near such a farm to transmit the power produced to the grid.

One or more solar panels are typically mounted to an I-beam. I-beams are driven into the ground until there is about 5-6 feet left above ground. The one or more solar panels are attached to one or more I-beams.

One issue with solar panels is vegetation management. Overgrown vegetation is not only unsightly, but generally can cause other problems, including electrical interference. On a larger solar panel farm vegetation management becomes more of an issue.

### SUMMARY

A solar panel accessory includes a vegetation management shield including a disk having a first side, and a second side. The disk has an I-beam-shaped opening therein. The opening passes through the disk. The vegetation management shield also includes a rib structure positioned between the first side of the disk and the second side of the disk. The disk has a center. The disk also includes, the rib structure including radially positioned ribs and circumferentially positioned ribs. One of the first side and the second side of the disk is domed. The disk is installed in a position so the domed structure sheds rain away from the opening passing through the disk. In another embodiment, one of the first side and the second side is sloped away from the opening passing through the disk.

A solar farm includes a plurality of I-beams having a first attached end and a free end. A plurality of solar panels are mounted to the free ends of the plurality of I-beams. The solar farm also includes a plurality of vegetation management shields attached to the plurality of I-beams. The vegetation management shields are positioned at or near the ground and prevent vegetative growth near the plurality of I-beams. At least one vegetation management shield includes a disk having a first side, and a second side. The disk of the at least one vegetation management shield has an I-beam-shaped opening therein. The opening passes through the disk. The disk also includes a rib structure positioned between the first side of the disk and the second side of the disk.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 is a perspective view of solar farm.

FIG. 2 is an elevational view several rows of solar panels mounted to one or more I-beams or posts.

FIG. 3A is a perspective view of a vegetation management shield fitted to an I-beam post, according to an example embodiment.

FIG. 3B is a close-up perspective view near the center of the vegetation management shield and the opening in the vegetation management shield as fitted to a post or an I-beam, according to an example embodiment.

FIG. 4 is a bottom view of the vegetation management shield shown in FIG. 3, according to an example embodiment.

FIG. 5 is a cross-sectional view of the vegetation management shield shown in FIG. 4 along line 5-5, according to an example embodiment.

FIG. 6 shows a close-up cross-sectional view of the center portion of the vegetation management shield which was encircled in FIG. 4, according to an example embodiment.

FIG. 7 is a perspective bottom view of the center portion of the vegetation management shield, according to an example embodiment.

FIG. 8 is a cross-sectional perspective top view of the center portion of the vegetation management shield, according to an example embodiment.

FIG. 9 is a perspective top view of another vegetation management shield for fitting to an I-beam post, according to an example embodiment.

FIG. 10 is a perspective view of the other embodiment of the vegetation management shield, according to an example embodiment.

FIG. 11 is a bottom view of yet another two-section vegetation management shield for fitting to an I-beam post, according to an example embodiment.

FIG. 12 is a perspective top view of yet another two-vegetation management shield for fitting to an I-beam post, according to an example embodiment.

FIG. 13 is a perspective top view of the two snap portions and brace and guide for yet another two-vegetation management shield for fitting to an I-beam post, according to an example embodiment.

FIG. 14 is a perspective bottom view of the two snap portions and brace and guide for yet another two-vegetation management shield for fitting to an I-beam post, according to an example embodiment.

FIG. 15 is a perspective top view of yet another two-part vegetation management shield for fitting to an I-beam post, according to an example embodiment.

### DETAILED DESCRIPTION

In the following pages, numerous specific details are set forth to provide a thorough understanding of the concepts underlying the described embodiments. It will be apparent, however, to one skilled in the art that the described embodiments may be practiced without some or all of these specific details. In the Detailed Description, reference is made to the accompanying drawings, which form a part hereof, and in which are shown by way of illustration specific embodiments in which the invention may be practiced. It should be understood that other embodiments may be utilized, and structural changes may be made without departing from the scope of the present invention.

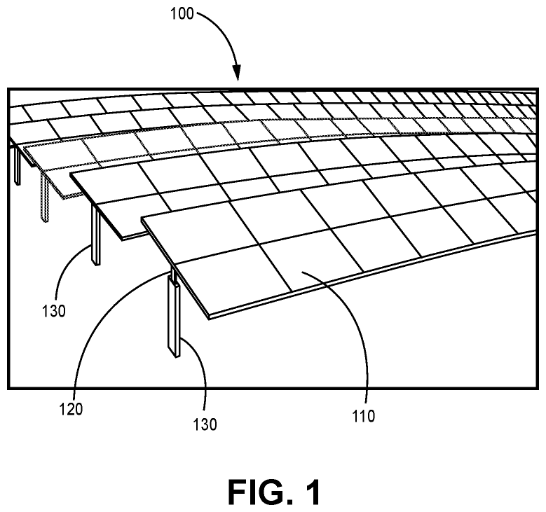

FIG. 1 is a perspective view of a solar farm 100. The solar farm 100 shown includes a large number of solar panels 110 or photovoltaic cells arranged in rows. The solar panels 110 can also be arranged in other geometric shapes as well. The solar panels themselves can come in various forms. Solar panels can be made from crystalline silicon. They are generally either monocrystalline or polycrystalline. The solar panels convert sunlight into useful electricity tend to generate direct current (DC) with voltages up to 1500V which is usually directly fed into the national grid or stored in batteries. The DC current is converted to alternating current (AC) using an inverter before it can be directly used or fed into the electrical grid. In some instances, the solar farm may use transformers. Generally, there is some form of a monitoring system used to control and manage the production of electrical energy produced. As shown in FIG. 1, the solar panels are mounted on racks 120 which are mounted to poles 130 that have been sunk into the ground. In many instances the poles 130 are I-beams with a substantial portion buried below the surface of the earth. The racks 120 which carry one or more solar panels are mounted to the poles 130. As shown in FIG. 1, the vegetation around the poles has been clipped. In FIG. 1, the season is winter and the vegetation is not growing.

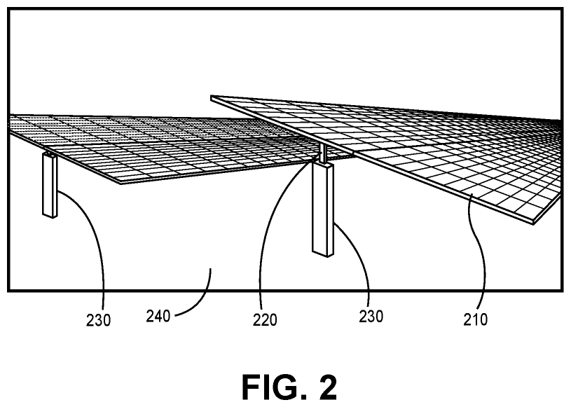

FIG. 2 is an elevational view of several rows of solar panels 210 mounted on racks 220 to one or more I-beams or posts 230. As can be seen, there is growing vegetation 240 on the earth, such as grasses, weeds, flowers, and the like. The back of the solar panels includes wires that carry the generated electricity. For the sake of safety, the circuits are generally wired to effectuate a ground fault interrupter circuit. In the even a hot wire connects to ground, the ground fault interrupter stops the flow of electricity in the circuit. This prevents electrocution should anyone be near a grounded wire carrying current. Ground faults can be caused my many things. One of the more common is when vegetation that has grown high touches an uninsulated portion of a hot wire. Even when a hot or current carrying wire is insulated, there is a possibility of an opening. The result will be halting the flow of electricity in the circuit. This is a nice safety feature but also can result in reduced profit for the owner of the solar farm. Most commonly, dew forms on grass or weeds early in the morning. If this happens to touch a wire with a bare spot or leak, the flow of electricity stops until the vegetation dries. Depending on how the solar panels are wired, this could mean that one or more solar panels will not be producing electricity. Thus, there is a need to mow or otherwise control the vegetation so that it does not get high enough to ground circuitry or wiring on the back of the solar panels 210.

It should be noted that if the vegetation is not controlled during the growing season, it also can cause ground faults during the winter months.

So mowing is key not only for safety but also necessary to assure continuous power production throughout the sunny part of the day from the solar panels 210 on a solar farm. Another problem is mowing around an I-beam. A mechanical mover simply cannot cut the vegetation near the main body of the I-beam. In other words, when looking at a cross section of an I-beam, it is difficult to get a mower of any size positioned to cut the vegetation growing along the sides and between the top and bottom of the I of the I-beam. A weed cutter would be more likely to remove or control vegetation at the difficult area, however, the time for controlling the vegetation increases if it cannot be done with just a mower. A farm of any size will simply need more manpower and time to control vegetation which also cuts into the profitability of such an operation.

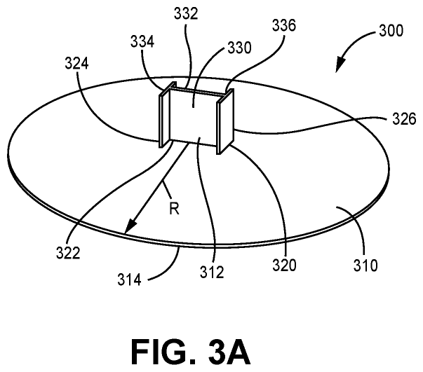

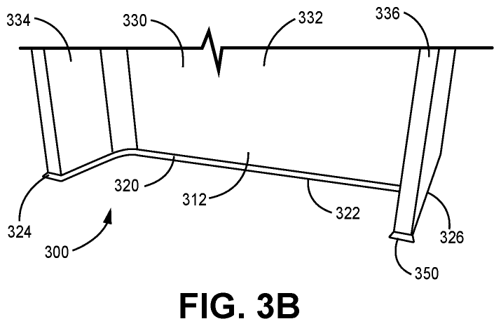

FIG. 3A is a perspective view of a vegetation management shield 300 fitted to a post or an I-beam 330, according to an example embodiment. The I-beam 330 is shortened and there is no rack or solar panel attached thereto. The vegetation management shield 300 is a disk 310 with a center 312 and with a radius R from the center 312 to an outer perimeter 314 of the disk 310. Positioned near the center 312 of the disk 310 is an opening 320. The opening 320 is in the cross-sectional shape of the I-beam 320. The cross-sectional shape of the I-beam 330 has an elongated main body 332 capped by a first cap 334 and a second cap 336 which traverse the main body 332. The opening 320, like the cross-section of the I-beam, has an elongated main body 322 capped by a first cap 324 and a second cap 326 which traverse the main body 322. The disk 310 is domed being higher at the center 312 and lower at the outer perimeter 314 so that it would shed water. The radius R of the disk 310, as shown, is about 4-5 times the length of the main body 342 of the I-beam. Of course, this radius could be larger or smaller. For example, the radius of the disk 310 could range from 2-7 times the length of the main body 332 of the I-beam 330 or could range from 3-6 times the length of the main body 332 of the I-beam 330. In the embodiment shown the disk has a radius of approximately 1.5 feet. Of course, this too could range from 1-2 feet or even 0.75-3 feet. The vegetation management shield 300 is made from a material that is substantial enough to prevent vegetation from growing through the material. The material of the vegetation management shield 300 also must not degrade in the sun or at least resist degradation from sun light. Additionally, the material should be tough or resilient so that if a mower or rotating blade of a mower would gouge the disk rather than crack the disk 310. The material should also have a long life. If possible, the life of the disk 300 should at least match the life of the solar panels. As shown in FIG. 3A, the disk 300 is on asphalt. It should be noted that generally the disk 300 will cover soil as the solar panels of a solar farm are generally placed in an agricultural field. Of course, the vegetation management shield could also be used in a yard of a residence and accomplish the same functions as discussed above.

FIG. 3B is a close-up perspective view near the center 312 and the opening 320 of a vegetation management shield 300 fitted to a post or an I-beam 330, according to an example embodiment. FIG. 3B is a closeup of the I-beam 330 and opening 320 in the vegetation management shield 300. Many of the elements numbered in FIG. 3B are the same as those shown in FIG. 3A. For the sake of simplicity and clarity, the description of these elements which are shown again will not be discussed again. Rather, the additional details which were not so readily seen will be discussed with respect to this FIG. Most notably, FIG. 3B shows a seal or lip 350 that rings the inner perimeter of the opening 320. The seal or lip 350 is made of a flexible material so that it can accommodate differences in dimensions on the various portions of the I-beam 330 to which it is placed over. The seal or lip 350 abuts most if not all the outer portions of the I-beam 330. When the vegetation management shield 300 is placed over the I-beam, the seal or tab is urged upwardly into engagement with the outer perimeter or outer portions of the I-beam 330. In FIG. 3B, this is most noticeable at the interface of the caps 334, 336 of the I-beam 330 and the opening portions 324, 326, respectively. This not only prevents or hinders vegetative growth but also sheds water away from the I-beam 330. The lip or seal 350 material will be more flexible than the material of the vegetation management shield 300.

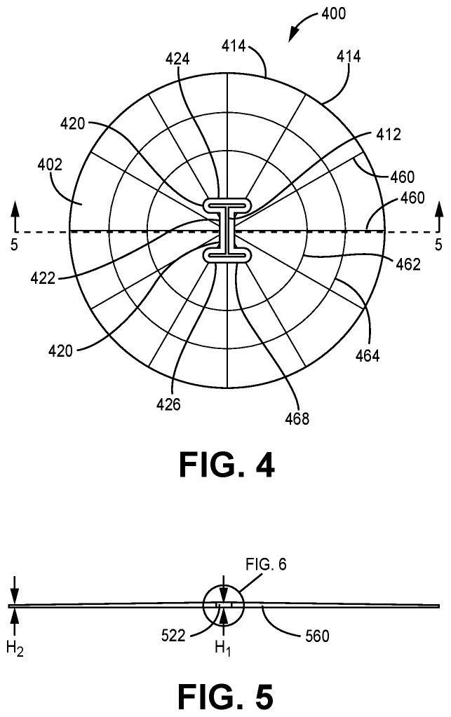

FIG. 4 is a bottom view of the vegetation management shield shown in FIG. 3, according to an example embodiment. The vegetation management shield 400 is a disk 410 with a center 412 and with a radius R from the center 412 to an outer perimeter 414 of the disk 410. The vegetation shield 400 has a bottom 402. Positioned near the center 412 of disk 410 is an opening 420. The opening 420 is in the cross-sectional shape of I-beam 320. The opening 420, like the cross-section of the I-beam, has an elongated main body 422 capped by a first cap 424 and a second cap 426 which traverse the main body 422. The disk 410 is domed being higher at the center 412 and lower at the outer perimeter 414 so that it would shed water. In the bottom view shown here, the center 412 of disk 410 is lower than the outer perimeter 414. The radius R of the disk 410, as shown, is about 4-5 times the length of the main body 442 portion of the opening which corresponds to the main body of an I-beam in cross section. The bottom of the disk 402 also includes a number of radial ribs 460. The radial ribs 460 provide strength to the disk 410. The bottom 402 also includes a plurality of circumferential ribs 462, 464. The circumferential ribs 462, 464 are formed with circumferential ribs 462, 464 to further strengthen the vegetation management shield 400. As shown in FIG. 4, there are 12 strengthening ribs 460. Of course, there could be more ribs 460 disposed radially on the bottom 402 of the disk 400. Also shown are two circumferential ribs 462, 464 disposed circumferentially about the center 412 of the disk 400. Of course, there could be more circumferential ribs than the two shown. A further strengthening structure 468 extends from the periphery of the opening 420 in the disk 400. The strengthening structure 468, the radial ribs 460, the on the circumferential ribs 462, 464, and the radial ribs 460 all terminate at a plane defined by the bottom edge of the periphery. This allows the disk 400 to sit flat on a flat surface. It should be noted that the ribs 460, 462, 464 and the strengthening structure 468 can have wall thicknesses that are thinner or thicker than shown in FIG. 4. The ribs 460, 462, 464 and the strengthening structure 468 are all interconnected for strength.

FIG. 5 is a cross-sectional view of the vegetation management shield 500 shown in FIG. 4 along line 5-5, according to an example embodiment. Shown in cross section is the rib 560. The opening 522 has a height of H₁. The outer periphery 514 of the disk 500 has a thickness H₂. H₂ is less than H₁ which shows that the vegetation management shield 500 is domed. H₁ can be in the range of 0.15 inch to 0.40 inch. H₂ can be in the range of 0.5 inch to 2.0 inches. The cross-sectional view also shows that the bottom of the disk 502 is substantially flat. In other words, there are no ribs that project down below the plane of the bottom 502. Of course, it is contemplated that in some embodiments, a spike or stake could be formed in the bottom surface to anchor the vegetation management shield 500.

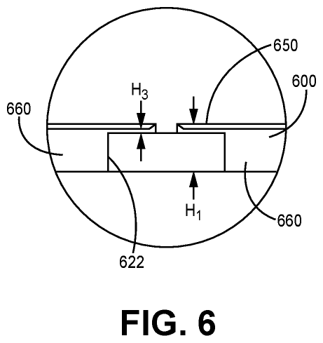

FIG. 6 shows a close-up cross-sectional view of the center portion of the vegetation management shield 600 which was encircled in FIG. 4, according to an example embodiment. The ribs 660 can be seen in the cross-sectional view. Also shown is the opening 620 for the I-beam and specifically the opening portion 622. The flexible material of the lip or seal 650 is also shown and has a thickness of H₃. As can be seen in FIG. 6, the thickness of the seal or lip is less than the dimension H₁ which is essentially the thickness of the rib and disk at or near the center of the vegetation management shield 600. The dimension H₃, in some embodiments, ranges from one-eighth inch to one half inch, for example.

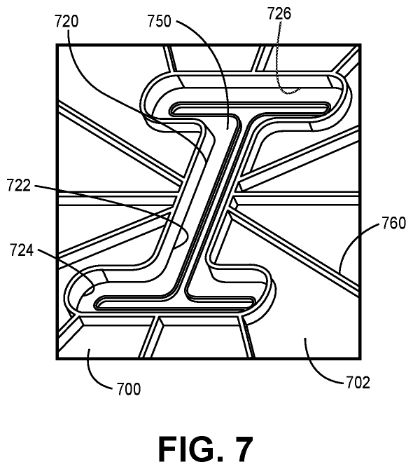

FIG. 7 is a perspective bottom view of the center portion 712 of the vegetation management shield 700, according to an example embodiment. The bottom 702 of the vegetation management shield 700 includes the various ribs 760 and strengthening elements described above. The vegetation management shield 700 includes the opening 720 having a main body 722, a first end cap 724 and a second end cap 726. FIG. 7 shows a seal 750 that is attached to the edge of the opening 720 for an I-beam. The material is thin, flexible and rugged. It will bend or flex to accommodate an I-beam when the shield is placed around an I-beam. The material is weather resistant and resistant to deterioration in the sunlight. The embodiment also includes a set of ribs 760 which provide stiffness to the vegetation management shield 700.

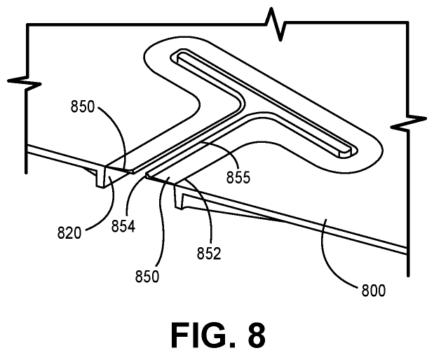

FIG. 8 is a cut-away perspective the top view of the center portion of another vegetation, management shield 800, according to an example embodiment. The top of the disk 800 includes the opening 820 for an I-beam. Around the opening is the seal or flexible lip 850. The lip or seal 850 has an attached end 852 and a free end 854 which ultimately will abut the surface of an I-beam over which the vegetation management shield will be installed. In this embodiment, the free end 845 is upset or enlarged when compared to the thickness of the flexible lip 850. In this one embodiment, the upset end 854 has about a 45 degree wall or fillet between the upset end 854 and the main portion of the seal or lip 850. Of course, any geometry could be used at the upset end.

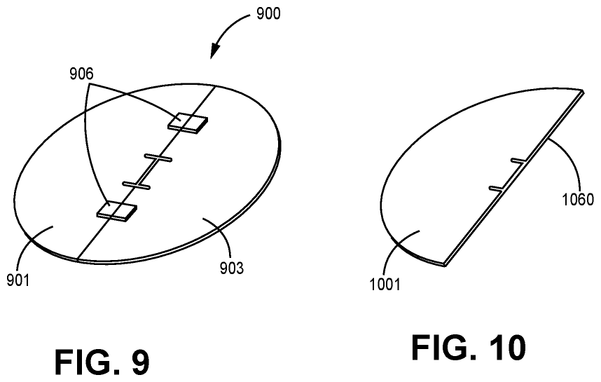

FIG. 9 is a perspective top view of another vegetation management shield 900 for fitting to an I-beam post, according to an example embodiment. The above embodiments are installed over an I-beam before a rack of solar panels or single solar panel is attached to the I-beam. This particular embodiment allows one to place a vegetation management shield 900 onto an I-beam after a solar panel or rack of solar panels has been attached to the I-beam. In this embodiment, the vegetation management shield 900 is formed as a first half 901 and a second half 903. In one embodiment, the two halves are identical. If identical, then the inventory of parts would be reduced to one part. The two halves 901, 903 are connected to one another after the first half 901 is placed on one side of an I-beam and the second half 903 is placed on the other side of the I-beam. The two halves 901, 903 are connected to one another by a connection mechanism 906. In one embodiment, the connection mechanism can be a hook and loop fastener, a male on one half that is snap fit to a female portion on the other half, or the like. Of course, the connection mechanism has to be durable and long lasting. It should be noted that the vegetation management shield does not have to be split into two identical halves. Other portions could be selected. The advantage of having two identical halves is that the number of parts needed is less, which simplifies manufacturing and inventory management when out in the field installing such shields.

FIG. 10 is a perspective view of the other embodiment of the vegetation management shield, according to an example embodiment. FIG. 10 shows one half 1001 of the vegetation shield 1000. Each half includes a radial rib 1060 along the central radial. This assures that the shield, such as the one shown in FIG. 9, will be sufficiently strengthened.

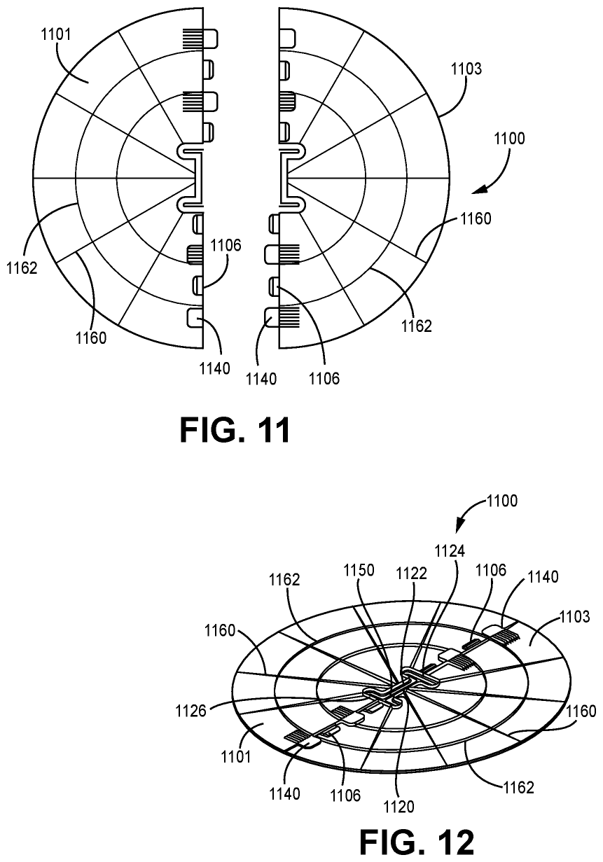

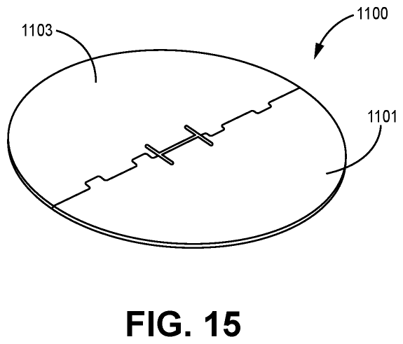

FIG. 11 is a bottom view of yet another two-part vegetation management shield 1100 for fitting to an I-beam post, according to an example embodiment. This particular embodiment allows one to place a vegetation management shield 1100 onto an I-beam after a solar panel or rack of solar panels has been attached to the I-beam. This can also be used to retrofit a field of solar panels that were not outfitted with these types of shields when originally installed or can be used to replace or cover a damaged vegetation management shield. In this embodiment, the vegetation management shield 1100 is formed as a first half 1101 and a second half 1103. Each half 1101, 1103 includes a guide portion and a snap portion which will be detailed in the FIGS. 14 and 15. In one embodiment, the first half 1101 and the second half 1103 are not identical as the snap portions and the guide portions have to be unique so that a solid connection can be made between the first half 1101 and the second half 1103. The two halves 1101, 1103 are connected to one another after the first half 1101 is placed on one side of an I-beam and the second half 1103 is placed on the other side of an I-beam. The two halves 1101, 1103 are connected to one another by a connection mechanism 1106. In this particular embodiment, the connection mechanism 1106 includes a plurality of first snap fit portions on one of the first half 1101 or the second half 1103, and a corresponding plurality of second snap fit portions on one of the second half 1103 or the first half 1101. The first half also includes braces and guides which also features a plurality of guide and brace portions 1140 on one of the first half 1101 or the second half 1103, and a corresponding plurality of guide and brace portions 1140 on one of the second half 1103 or the first half 1101. Of course, the connection mechanism 1106 is designed to be durable and long lasting. The back side of each of the first half 1101 and the second half 1103 includes radial ribs 1160 and annular ribs 1162 which stiffen each of the halves and assures proper alignment of the first half 1101 and the second half 1103 as they are assemble one to the other.

FIG. 12 is a perspective bottom view of the two-part vegetation management shield 1100 for fitting to an I-beam post as assembled, according to an example embodiment. As assembled, the first half 1101 and the second half 1103 are properly aligned by the plurality of guide and brace portions 1140, and the first half 1101 and the second half 1103 are securely connected to one another by the connection mechanism 1106. The assembled two-part vegetation management shield 1100 includes an opening 1120 for an I-beam which includes an opening for a main body 1122, a first end cap 1124 and a second end cap 1126. The opening 1120 also includes a seal 1150 that is attached to the edge of the opening 1120 for an I-beam. It should be noted that the vegetation management shield does not have to be split into two halves. Other portions could be selected. The advantage of having two halves is that the storage for parts needed is less, which simplifies manufacturing and inventory management when out in the field installing such shields.

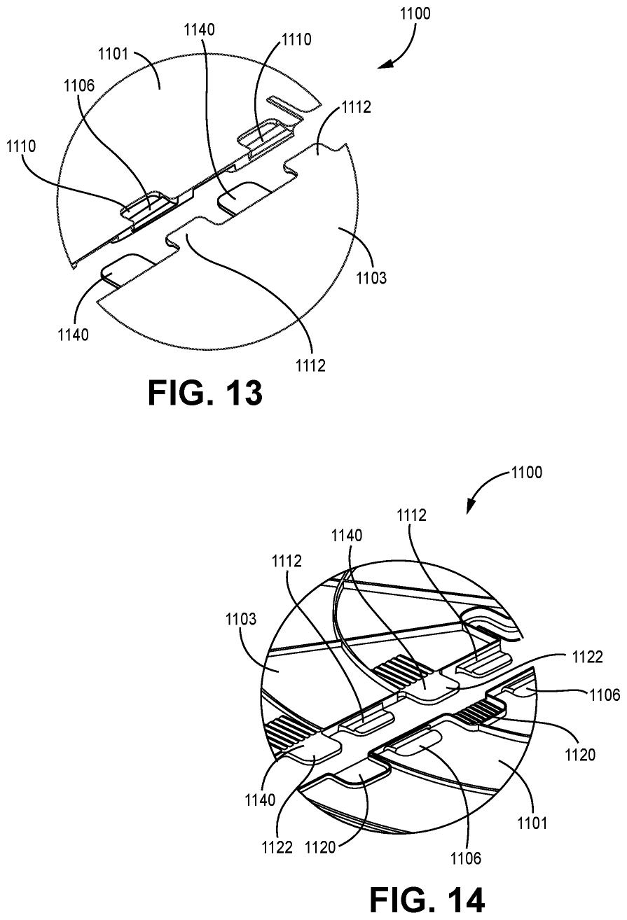

FIG. 13 is a perspective top view of the two snap portions 1106 and brace and guide portions 1140 for yet another two-part vegetation management shield for fitting to an I-beam post, according to an example embodiment. FIG. 14 is a perspective bottom view of the two snap portions and brace and guide for yet another two-part vegetation management shield for fitting to an I-beam post, according to an example embodiment. Now referring to both FIGS. 13 and 14, first half 1101 includes a plurality of pawl portions 1110. Second half 1103 includes a plurality of toothed portions 1112 which engage the pawl portions 1100 during assembly. The teeth engage the pawls to hold the first half 1101 to the second half 1103. The first half 1101 also includes guide pockets 1120 which are sized to receive tab braces. These assure that the first half 1101 and the second half 1103 align with one another during assembly. The guide pocket 1120 is sized to fit the tab braces 1122. Thickened portions in the guide pockets and near the tab braces provide added strength to the brace and guide portions 1106.

FIG. 15 is a perspective top view of the two-part vegetation management shield 11X) shown in FIGS. 11-14 for fitting to an I-beam post, according to an example embodiment. When assembled, the top of the two-part vegetation management shield 1100 is relatively smooth so as to minimize grooves or slots which eventually can house soil in which vegetation can sprout and grow to minimize and eliminate problems discussed in the background section above.

The various embodiments would provide many advantages, some of which are mentioned here. The advantages include forming a mechanical barrier to vegetation so that the vegetation does not reach exposed wiring and ground the system or a portion thereof and trigger an interruption that would stop the flow of generated power. This makes a solar farm safer for people that may have to maintain the solar farm. It also results in less interruptions in the generation of power using the solar panels. This means maximizing the use of the equipment and the profits from sales of power from the solar farm. In addition, using the vegetation shields will speed mowing of the vegetation around the solar farm. With such shields in place it is contemplated that the amount of time to mow the vegetation at a farm will be halved. Less equipment will be required to do the maintenance. For example, rather than carrying weed whips a zero radius turn mower will be able to do the task. Yet a further advantage is that during the install, installers will have a safe place to stand. These are but a few advantages. There are others. These and other advantages stem from the above described and shown embodiments.

A vegetation management shield includes a disk having a first side, and a second side. The disk has an I-beam-shaped opening therein. The opening passes through the disk. The vegetation management shield also includes a rib structure positioned between the first side of the disk and the second side of the disk. The disk has a center. The disk also includes the rib structure including radially positioned ribs and circumferentially positioned ribs. One of the first side and the second side of the disk is domed. The disk is installed in a position so the domed structure sheds rain away from the opening passing through the disk. In another embodiment, one of the first side and the second side is sloped away from the opening passing through the disk.

A vegetation management shield includes a disk having a first portion, and a second portion. The first portion and the second portion fit together to form a shield having an I-beam-shaped opening therein. Each of the first portion and the second portion have a first side, and a second side. The I-beam-shaped opening passes through the disk. The vegetation management shield further includes a rib structure positioned between the first side of the disk and the second side of the disk. In one embodiment, the first portion and the second portion are substantially identical. In another embodiment, the first portion and the second portion differ. The vegetation management shield also includes an attachment mechanism for attaching the first portion and the second portion.

A solar farm includes a plurality of I-beams having a first attached end and a free end. A plurality of solar panels are mounted to the free ends of the plurality of I-beams. The solar farm also includes a plurality of vegetation management shields attached to the plurality of I-beams. The vegetation management shields are positioned at or near the ground and prevent vegetative growth near the plurality of I-beams. At least one vegetation management shield includes a disk having a first side, and a second side. The disk of the at least one vegetation management shield has an I-beam-shaped opening therein. The opening passes through the disk. The disk also includes a rib structure positioned between the first side of the disk and the second side of the disk.

While the embodiments have been described in terms of several embodiments, there are alterations, permutations, and equivalents, which fall within the scope of these general concepts. It should also be noted that there are many alternative ways of implementing the various apparatuses and methods of the present embodiments. It is therefore intended that the following appended claims be interpreted as including all such alterations, permutations, and equivalents as fall within the true spirit and scope of the described embodiments.

What is claimed:

1. A vegetation management shield comprising:
a disk having
a first side; and
a second side, the disk having an I-beam-shaped opening therein, the opening passing through the disk; and
a rib structure positioned between the first side of the disk and the second side of the disk.

2. The vegetation management shield of claim 1 wherein the disk has a center, the rib structure including radially positioned ribs and circumferentially positioned ribs.

3. The vegetation management shield of claim 1 wherein one of the first side and the second side is domed and wherein the disk is installed in a position to shed rain away from the opening passing through the disk.

4. The vegetation management shield of claim 1 wherein one of the first side and the second side is sloped away from the opening passing through the disk.

5. A vegetation management shield comprising:
a disk having
a first portion; and
a second portion, the first portion and the second portion fitting together to form a shield having an I-beam shaped opening, each of the first portion and the second portion having:
a first side; and
a second side, the disk having an I-beam-shaped opening therein, the opening passing through the disk.

6. The vegetation management shield of claim 5 further including a rib structure positioned between the first side of the disk and the second side of the disk.

7. The vegetation management shield of claim 5 wherein the first portion and the second portion are substantially identical.

8. The vegetation management shield of claim 5 further comprising an attachment mechanism for attaching the first portion and the second portion.

9. A solar farm comprising:
a plurality of I-beams positioned having a first attached end and a free end;
a plurality of solar panels mounted to the free ends of the plurality of I-beams;
a plurality of vegetation management shields attached to the plurality of I-beams,
at least one vegetation management shield comprising:
a disk having
a first side; and
a second side, the disk having an I-beam-shaped opening therein, the opening passing through the disk; and
a rib structure positioned between the first side of the disk and the second side of the disk.

10. The solar farm of claim 9 wherein the disk of the at least one vegetation management shield has a center, the rib structure including radially positioned ribs and circumferentially positioned ribs.

11. The solar farm of claim 9 wherein one of the first side and the second side of the disk of the at least one vegetation management shield is domed, the disk installed in a position to shed rain away from the opening passing through the disk.

12. The solar farm of claim 9 wherein one of the first side and the second side of the disk of the at least one vegetation management shield is sloped away from the opening passing through the disk.

13. The solar farm of claim 9 wherein one of the first side and the second side of the disk of the at least one vegetation management shield vegetation management shield includes:
a disk having
a first portion; and
a second portion, the first portion and the second portion fitting together to form a shield having an I-beam shaped opening, each of the first portion and the second portion having:
a first side; and
a second side, the disk having an I-beam-shaped opening therein, the opening passing through the disk.

14. The solar farm of claim 13 wherein one of the first portion and the second portion of the disk of the at least one vegetation management shield further comprises:
a set of snap portions; and
a set of guide and brace portions.

15. The solar farm of claim 14 wherein the set of snap portions further comprises:
a first tab having teeth; and
a recess shaped to receive the first tab, the recess also including pawls that engage the teeth of the first tab.

16. The solar farm of claim 14 wherein the set of guide and brace portions further comprises:
a second tab with a brace;
a guide pocket shaped to receive the second tab, the second tab and the guide pocket aligning the first portion and the second portion of the disk.

17. The of vegetation management shield of claim 5 wherein one of the first portion and the second portion of the disk of the at least one vegetation management shield further comprises:
a set of snap portions; and
a set of guide and brace portions.

18. The vegetation management shield of claim 17 wherein the set of snap portions further comprises:
a first tab having teeth; and
a recess shaped to receive the first tab, the recess also including pawls that engage the teeth of the first tab.

19. The vegetation management shield of claim 17 wherein the set of guide and brace portions further comprises:
a second tab with a brace;
a guide pocket shaped to receive the second tab, the second tab and the guide pocket aligning the first portion and the second portion of the disk.
